(19) United States
(12) Patent Application Publication
(10) Pub. No.: US 2010/0123372 A1
(43) Pub. Date: May 20, 2010

(54) MOTOR INTEGRATED TO ELECTRONIC DEVICE

(75) Inventors: Guang-Miao Huang, Kaohsiung City (TW); Guo-Jhih Yan, Kaohsiung City (TW); Hsin-Te Wang, Taipei County (TW); Jing-Hui Wang, Taipei County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: METAL INDUSTRIES RESEARCH & DEVELOPMENT CENTRE, Kaohsiung (TW)

(21) Appl. No.: 12/617,195

(22) Filed: Nov. 12, 2009

(30) Foreign Application Priority Data
Nov. 14, 2008 (TW) 097144117

(51) Int. Cl. H02K 7/14; H02K 3/26

(52) U.S. Cl. 310/67 R; 310/208

(57) ABSTRACT

An integrated motor, integrated to a structural part and an electronic substrate of an electronic device, includes a base formed on the structural part of the electronic device, a rotor having a load, and a stator having a plurality of winding coils and a driving circuit respectively shaped on the electronic substrate of the electronic device, for driving the rotor to rotate in a specific direction.

### CROSS-REFERENCE TO RELATED APPLICATION

This application claims the benefit of Taiwan Patent Application No. 097144117 filed on Nov. 14, 2008, which is hereby incorporated by reference for all purposes as if fully set forth herein.

### BACKGROUND OF THE INVENTION

1. Field of the Invention

The present invention relates to a motor integrated to an electronic device, and more particularly to a motor, in which rotating parts and fixed parts of the motor are directly integrated to a structural part and an electronic substrate of an electronic device.

2. Related Art

Usually, in an electronic device, if a motor (or an electric motor) needs to be placed as a source of motive power of a heat sink fan or a source of vibration, the complete motor product is placed in the electronic product. In addition, in order to save the space, the circuit board needs to be manufactured to an appropriate shape, so as to match the shape of the motor product (for example, in U.S. Pat. No. 7,248,473), or the motor is independently designed and manufactured. Moreover, a mounting portion needs to be considered after the motor is already manufactured, and then the motor is connected to the circuit of the electronic device on which the motor is mounted (for example, in U.S. Pat. No. 5,943,214). Further, a miniature fan motor is directly mounted on a printed circuit board (PCB) (for example, in U.S. Pat. No. 5,478,221), in which a complete motor product is directly mounted on the circuit board through a bearing base in an axial direction or a radial direction. The adopted motor product is still independently designed and manufactured, such that it is rather difficult to thin the motor in space, and the cost is increased due to the repeated use of the resources.

### SUMMARY OF THE INVENTION

The present invention is directed to a motor integrated to a structural part and an electronic substrate of an electronic device, in which rotating parts of the motor are directly combined with the structural part, and fixed parts of the motor are formed on the electronic substrate.

In order to solve the above problem, the present invention provides a motor integrated to a structural part of an electronic device and an electronic substrate correspondingly mounted on the structural part. The motor includes a based formed on the structural part, a rotor having at least one load, and a stator having a plurality of winding coils and a driving circuit respectively shaped on the electronic substrate, for driving the rotor.

In the present invention, the base of the motor component is directly formed on the structural part of the electronic device, and the motor is integrated to the existing structure of the electronic product, such that the motor is further thinned in space. In the present invention, the rotating parts (such as the bearing, the shaft, and the rotor) of the motor and a load (such as a fan blade or an eccentric block) are integrated to the structural part or a case of the existing electronic product, so as to relatively enhance the stability of the structure, reduce the parts, thus facilitating assembling and mass production. In the present invention, the winding and the driving circuit of the stator of the motor are integrated to the circuit board of the electronic product, so as to form a motor module correspondingly with the rotor portion on the electronic product component, such that the manufacture in the same batch is easily performed, the entire cost is reduced, and a thickness and number of the parts of the motor are reduced. In addition, the electronic device may be a heat sink module, an optical disc drive spindle motor, a hard disk drive, a solid-state drive (SSD), a micro-generator, a micro-pump, a cell phone, a mobile Internet device, a notebook computer, or a mini notebook computer.

### BRIEF DESCRIPTION OF THE DRAWINGS

The present invention will become more fully understood from the detailed description given herein below for illustration only, and thus are not limitative of the present invention, and wherein:

FIG. 1 is a three-dimensional (3D) exploded view of a motor according to one embodiment of the present invention, in which a rotor is located between a base and a stator;

FIG. 2 is a combined cross-sectional view of FIG. 1;

FIG. 3 is a cross-sectional view of a motor according to one embodiment of the present invention, in which a rotor is located between a base and a stator, and a shaft is connected to an electronic substrate;

FIG. 4 is a cross-sectional view of a motor according to one embodiment of the present invention, in which a stator is located between a base and a rotor;

FIG. 5A is a 3D exploded view of a motor according to one embodiment of the present invention, in which the motor is integrated to a cell phone;

FIG. 5B is a cross-sectional view of a motor according to one embodiment of the present invention, in which the rotor is disposed between a main board and an upper case of the cell phone;

FIG. 5C is a cross-sectional view of a motor according to one embodiment of the present invention, in which one rotor is disposed between a main board and a bottom case of the cell phone and the other rotor is disposed between a main board and an upper case of the cell phone;

FIG. 6A is a 3D exploded view of a motor according to one embodiment of the present invention, in which the motor is integrated to a display card having a front heat dissipation part;

FIG. 6B is a 3D exploded view of a motor according to one embodiment of the present invention, in which the motor is integrated to a display card having a back heat dissipation part;

FIG. 6C is a 3D exploded view of a motor according to one embodiment of the present invention, in which the motor is integrated to a display card having a front heat dissipation part and a back heat dissipation part; and

FIG. 7 is a 3D exploded view of a motor according to one embodiment of the present invention, in which the motor is integrated to a notebook computer.

### DETAILED DESCRIPTION OF THE INVENTION

Preferred embodiments of the present invention are described in detail below with accompanying drawings.

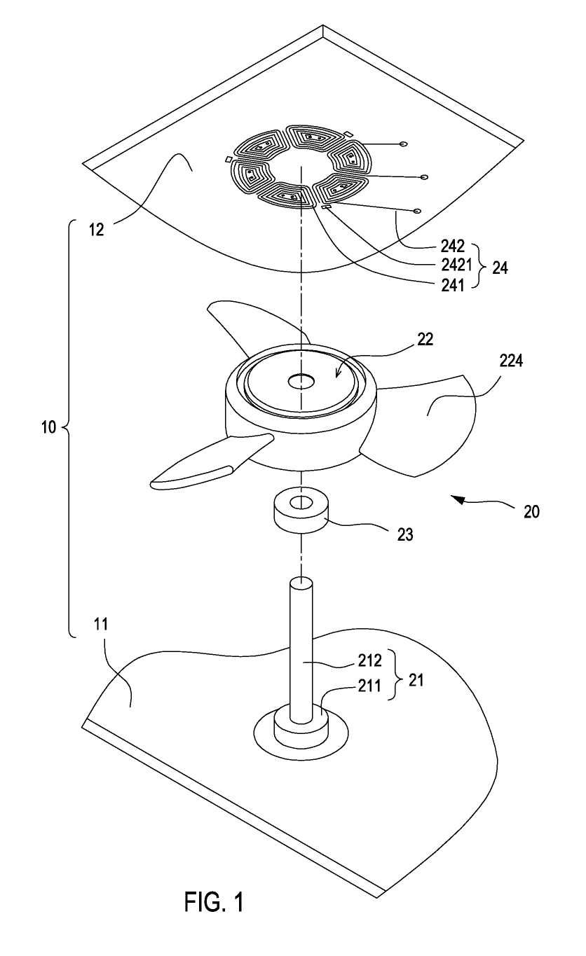

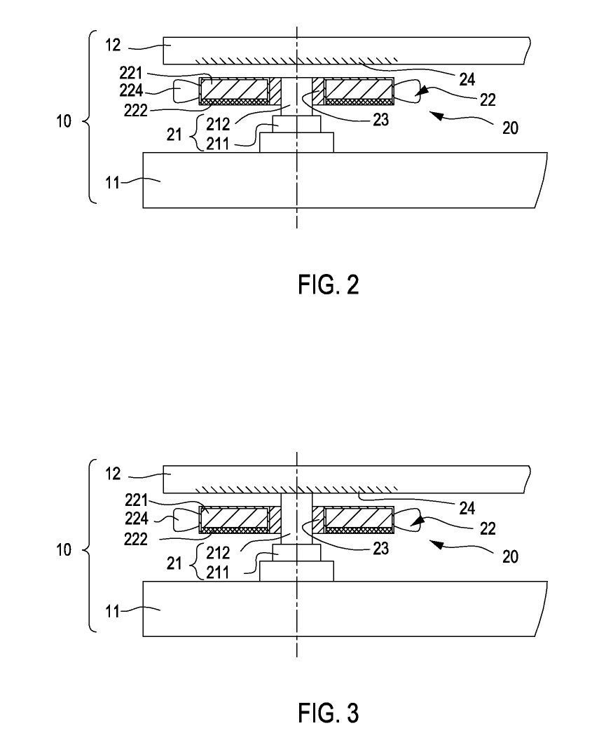

FIG. 1 is a three-dimensional (3D) exploded view of a motor according to one embodiment of the present invention, in which a rotor is located between a base and a stator, and FIG. 2 is a combined cross-sectional view of FIG. 1. Referring to FIGS. 1 and 2, a motor 20 integrated to an electronic device 10 according to an embodiment of the present invention is integrated to a structural part 11 of the electronic device 10 and an electronic substrate 12 correspondingly mounted on the structural part 11. The motor 20 includes a base 21 directly shaped on the structural part 11, a rotor 22 having at least one load, a bearing 23 disposed between and connected to the rotor 22 and the base 21, and making the rotor 22 to rotate relative to the base 21, and a stator 24 respectively shaped on the electronic substrate 12, in which the stator 24 has a plurality of winding coils 241 and a driving circuit 242, for driving the rotor 22.

Usually, the electronic device 10 includes the structural part 11 and an electronic part, the structural part 11 is, for example, a case, a heat sink, a press button, and the like, and the electronic part is the electronic substrates 12 such as a print circuit board (PCB) and a print circuit board assembly (PCBA) having electronic components mounted thereon. In the present invention, rotating parts of the motor 20, such as the base 21, the bearing 23, and the rotor 22 (and a fan blade, an eccentric block, or other loads), are directly integrated to the structural part, and the winding coils 241 and the driving circuit 242 of the stator 24 of the motor 20 are directly integrated to the electronic substrate 12, and manufactured in the process of manufacturing the electronic substrate 12. The driving circuit 242 according to one embodiment may not have a sensor, or may further include a sensing unit 2421, in which the sensing unit 2421 may be a sensing circuit shaped on the electronic substrate 12 or a Hall element. The rotor 22 includes a permanent magnet 221 and a yoke 222 disposed corresponding to the permanent magnet 221. The base 21 may have two different types, for example, the base 21 includes a bearing seat 211 formed on the structural part 11 and a shaft 212 disposed on the bearing seat 211, an inner diameter of the bearing 23 is connected to the shaft 212, an outer diameter of the bearing 23 is connected to the rotor 22, and the shaft 212 of the structure does not rotate. In one embodiment, the base 21 includes a bearing seat 211 formed on the structural part 11, the rotor 22 includes a shaft 212, an outer diameter of the bearing 23 is connected to the bearing seat 211, an inner diameter of the bearing 23 is connected to the shaft 212, and the shaft 212 of the structure rotates together with the rotor 22. An appropriate type of the bearing 23 in the embodiments may be selected according to the type of the motor, for example, a ball bearing or an oil-retaining bearing, but it is not limited here. For example, a lube layer having a lubricating effect is disposed between the rotor 22 and the base 21, and the lube layer may be grease, Teflon, or other metal plating layer, depending on the different aspects of the bearing 23.

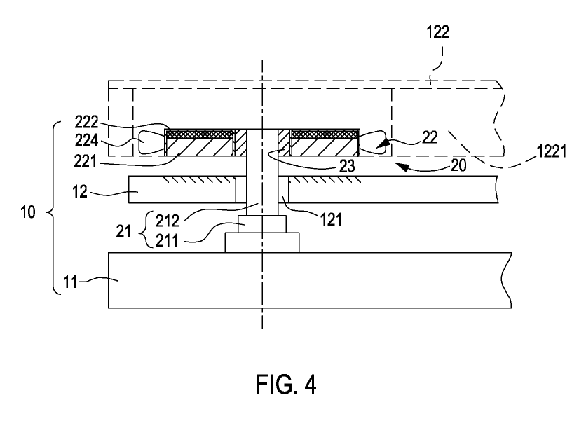

According to different configuration structures of the electronic device 10, stacking positions of the rotor 22, the stator 24, and the base 21 may have different changes, for example, the rotor 22 is disposed between the base 21 and the stator 24 (as shown in FIGS. 1 and 2), in this embodiment, one end of the shaft 212 is connected to the bearing seat 211, and the other does not contact with or is connected to the electronic substrate 12, as shown in FIG. 3. FIG. 3 is a cross-sectional view of the motor according to one embodiment of the present invention, in which the rotor is located between the base and the stator, and the shaft is connected to the electronic substrate. In addition, the stator 24 may also be disposed between the base 21 and the rotor 22, and the electronic substrate 12 has a through hole 121 allowing the shaft 212 of the base 21 to pass through, such that the base 21 is assembled with the rotor 22 through the bearing 23, as shown in FIG. 4. FIG. 4 is a cross-sectional view of the motor according to the embodiment of the present invention, in which the stator is located between the base and the rotor.

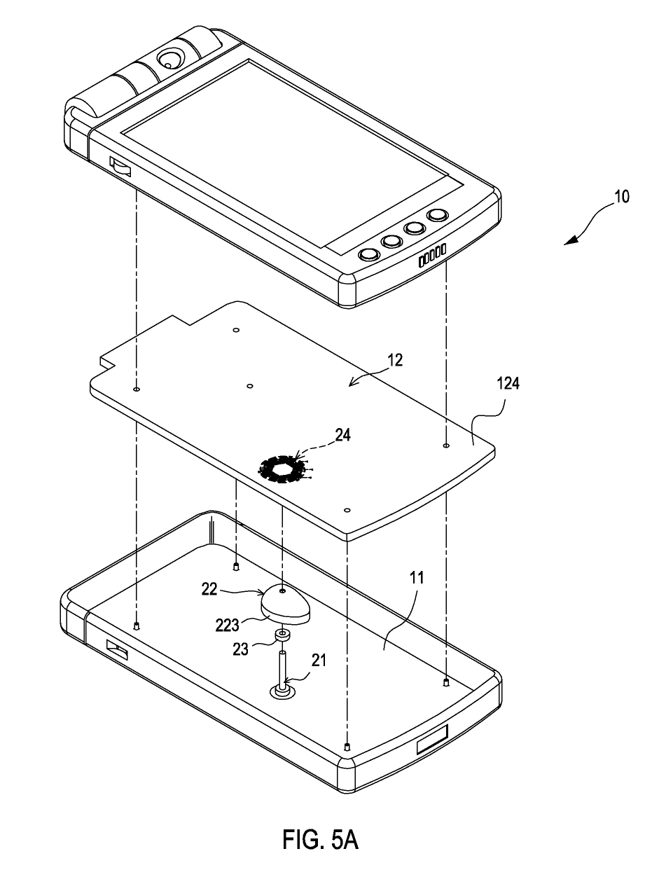

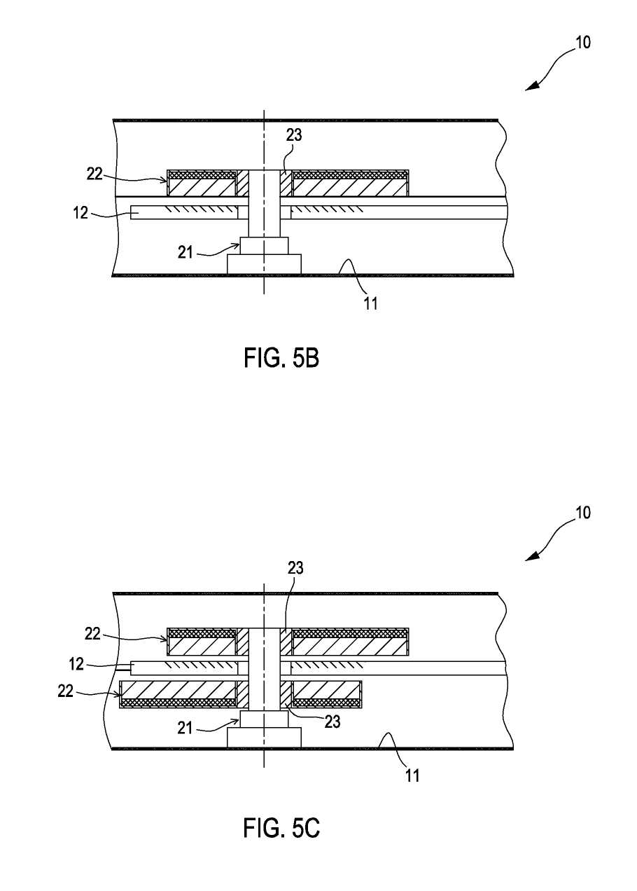

Referring to FIG. 5A, a 3D exploded view of the motor according to one embodiment of the present invention is shown, in which the motor is integrated to a cell phone. Particularly, in this embodiment, the motor 20 is integrated to the electronic device 10 of a cell phone. The structural part 11 is a case, the electronic substrate 12 is a main board 124, the load of the rotor 22 is an eccentric block 223, and the configuration manner thereof is the same as the type as shown in FIG. 2. In addition, as shown in FIG. 5A, the rotor 22 is disposed between the main board 124 and a bottom case of the cell phone. The rotor 22 may possibly be disposed between the main board 124 and an upper case of the cell phone as shown in FIG. 5B. Moreover, there may have two rotors 22. One rotor is disposed between the main board 124 and a bottom case of the cell phone, and the other one is disposed between the main board 124 and an upper case of the cell phone as shown in FIG. 5C.

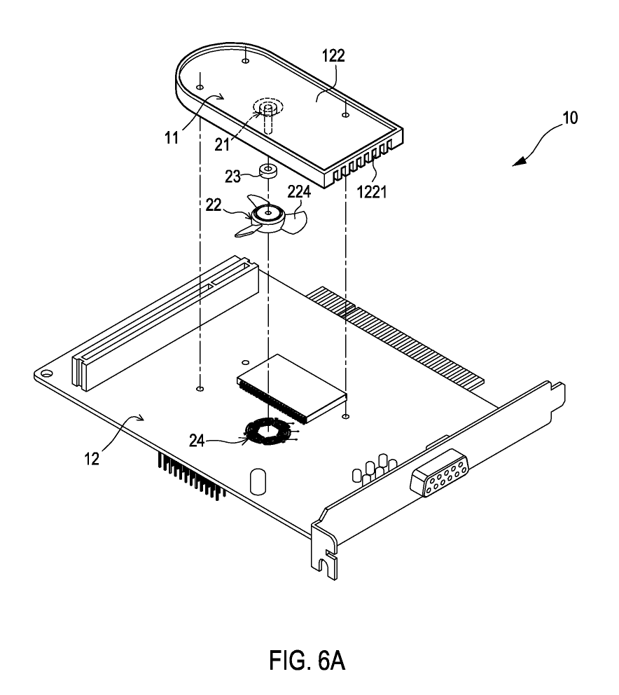

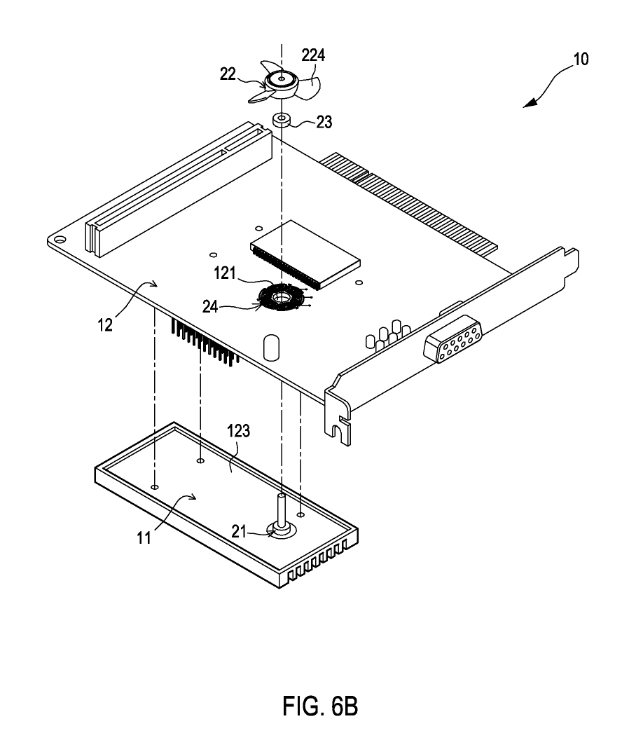

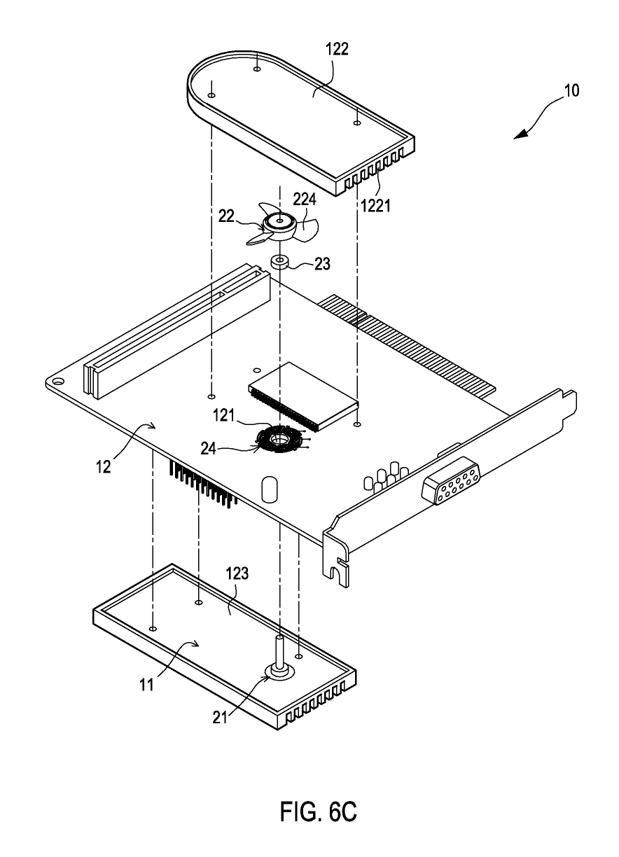

Referring to FIG. 6A, a 3D exploded view of the motor according to one embodiment of the present invention is shown, in which the motor is integrated to a display card having a front heat dissipation part. In this embodiment, mainly the motor 20 is integrated to the electronic device 10 of a display card. The electronic substrate 12 of the display card has a front side and a back side, and main electronic components are mounted on the front side. A front heat dissipation part 122 is disposed on the front side, and the front heat dissipation part 122 is the structural part 11 of this embodiment. The base 21 of this embodiment is formed in the front heat dissipation part 122, and the rotor 22 may be completely disposed in the front heat dissipation part 122. The stator 24 of this embodiment is formed on the electronic substrate 12 (that is, the PCBA) of the display card. The configuration manners of the base 21, the rotor 22, and the stator 24 may be obtained with reference to the embodiment of FIG. 2.

Referring to FIG. 6B, a 3D exploded view of the motor according to one embodiment of the present invention is shown, in which the motor is integrated to a display card having a back heat dissipation part. In addition, there is another type of the display card in which the back side of the display card has a back plate or a back heat dissipation part 123 disposed thereon. In the embodiment of the present invention corresponding to this type, the base 21 is formed on the back plate or the back heat dissipation part 123, the rotor 22 is located on the front side of the electronic substrate 12 of the display card, and the stator 24 is still formed on the electronic substrate 12 of the display card. The configuration manners of the base 21, the rotor 22, and the stator 24 may be obtained with reference to the embodiment of FIG. 4.

Referring to FIG. 6C, a 3D exploded view of the motor according to one embodiment of the present invention is shown, in which the motor is integrated to a display card having a front heat dissipation part and a back heat dissipation part. In the embodiment of FIG. 6B, the front heat dissipation part 122 may be further disposed on the front side of the electronic substrate 12 of the display card, and the rotor 22 is located in a heat sink 1221 of the front heat dissipation part 122 (referring to FIG. 4).

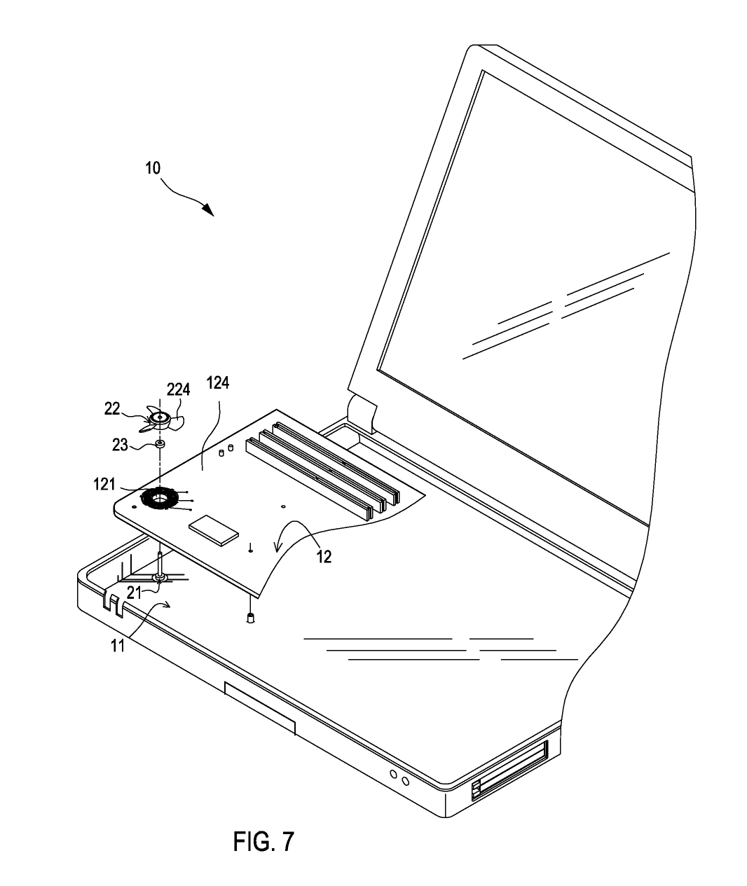

Referring to FIG. 7, a 3D exploded view of the motor according to one embodiment of the present invention is shown, in which the motor is integrated to a notebook computer. Particularly, in this embodiment, the motor 20 is integrated to the electronic device 10 of a notebook computer. The electronic substrate 12 is a main board 124, the structural part 11 is a case, and the load of the rotor 22 is a fan blade 224. The configuration manners may be obtained with reference to the embodiment of FIG. 4.

In the present invention, the base of the motor component is directly formed on the structural part of the electronic device, such that an entire thickness is thinned. In the present invention, the rotating parts of the motor and the load are integrated to the structure or the case of the existing electronic product, so as to relatively enhance the stability of the structure, reduce the parts, thus facilitating assembling and mass production. In the present invention, the winding and the driving circuit of the stator of the motor are integrated to the circuit board of the electronic product, so as to form a motor module correspondingly with the rotor portion on the electronic product component, such that the manufacture in the same batch is easily performed, the entire cost is reduced, and a thickness and number of the parts of the motor are reduced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A motor integrated to an electronic device, wherein the motor is integrated to a structural part of the electronic device and an electronic substrate correspondingly mounted on the structural part, comprising:
a base, formed on the structural part;
a rotor, having at least one load; and
a stator, having a plurality of winding coils and a driving circuit respectively shaped on the electronic substrate, for driving the rotor.

2. The motor integrated to an electronic device according to claim 1, wherein the driving circuit further comprises a sensing unit.

3. The motor integrated to an electronic device according to claim 2, wherein the sensing unit is at least one sensing circuit or at least one Hall element.

4. The motor integrated to an electronic device according to claim 1, wherein the rotor comprises a permanent magnet and a yoke disposed corresponding to the permanent magnet.

5. The motor integrated to an electronic device according to claim 1, wherein the base comprises a bearing seat formed on the structural part, a shaft and a bearing disposed on the bearing seat, an inner diameter of the bearing is connected to the shaft, and an outer diameter of the bearing is connected to the rotor.

6. The motor integrated to an electronic device according to claim 1, wherein the base comprises a bearing seat formed on the structural part, the rotor comprises a shaft and a bearing, an outer diameter of the bearing is connected to the bearing seat, and an inner diameter of the bearing is connected to the shaft.

7. The motor integrated to an electronic device according to claim 1, wherein the rotor is located between the base and the stator.

8. The motor integrated to an electronic device according to claim 1, wherein the stator is located between the base and the rotor, and the electronic substrate has a through hole allowing the base to assemble with the rotor through a bearing.

9. The motor integrated to an electronic device according to claim 8, further including a rotor wherein the rotor is located between the base and the stator.

10. The motor integrated to an electronic device according to claim 7, wherein the electronic device is a display card.

11. The motor integrated to an electronic device according to claim 10, wherein the electronic substrate of the display card has a front side and a back side, a front heat dissipation part is disposed on the front side, and the structural part is the front heat dissipation part.

12. The motor integrated to an electronic device according to claim 11, wherein the rotor is disposed in the front heat dissipation part.

13. The motor integrated to an electronic device according to claim 8, wherein the electronic device is a display card.

14. The motor integrated to an electronic device according to claim 10, wherein the electronic substrate has a front side and a back side, a back heat dissipation part or a back plate is disposed on the back side, the structural part is the back heat dissipation part or the back plate, and the rotor is located on the front side of the electronic substrate.

15. The motor integrated to an electronic device according to claim 14, wherein a front heat dissipation part is disposed on the front side of the electronic substrate, and the rotor is located in the front heat dissipation part.

16. The motor integrated to an electronic device according to claim 1, wherein the load of the rotor is a fan blade or an eccentric block.

17. The motor integrated to an electronic device according to claim 1, wherein the electronic substrate is a printed circuit board (PCB).

18. The motor integrated to an electronic device according to claim 1, wherein the electronic substrate is a printed circuit board assembly (PCBA).

19. The motor integrated to an electronic device according to claim 1, wherein the structural part is a case of the electronic device.

20. The motor integrated to an electronic device according to claim 1, wherein the electronic device is a heat sink module or an optical disc drive spindle motor.

21. The motor integrated to an electronic device according to claim 1, wherein the electronic device is a hard disk drive, a solid-state drive (SSD), a micro-generator, or a micro-pump.

22. The motor integrated to an electronic device according to claim 1, wherein the electronic device is a cell phone, a mobile Internet device, a notebook computer, or a mini notebook computer.
